(19) United States
(12) Patent Application Publication
(10) Pub. No.: US 2024/0004258 A1
(43) Pub. Date: Jan. 4, 2024

(54) OPTICAL MODULATOR

(71) Applicant: Nippon Telegraph and Telephone Corporation, Tokyo (JP)

(72) Inventor: Hidetaka Nishi, Tokyo (JP)

(21) Appl. No.: 18/253,888

(22) PCT Filed: Dec. 2, 2020
(86) PCT No.: PCT/JP2020/044810

§ 371 Date: May 23, 2023

(51) Int. Cl. G02F 1/225; G02F 1/21

(52) U.S. Cl. CPC G02F 1/2255; G02F 1/212

(57) ABSTRACT

An optical modulator includes a core formed above a lower cladding layer and a first metal layer and a second metal layer disposed above the lower cladding layer with the core being interposed in between. The optical modulator also includes an upper cladding layer formed above the lower cladding layer, covering the core, the first metal layer, and the second metal layer. In addition, the optical modulator includes a resistor formed on the upper cladding layer and above the core. The resistor is electrically connected to the first metal layer by a first penetrating wiring line penetrating the upper cladding layer and is electrically connected to the second metal layer by a second penetrating wiring line penetrating the upper cladding layer.

### CROSS-REFERENCE TO RELATED APPLICATIONS

This application is a national phase entry of PCT Application No. PCT/JP2020/044810, filed on Dec. 2, 2020, which application is hereby incorporated herein by reference.

### TECHNICAL FIELD

The present invention relates to an optical modulator that uses an electro-optical material.

### BACKGROUND

Optical-waveguide-type high-speed phase shifters have been researched and developed as key devices for various applications that use Tbit/s-class ultra-high-speed optical communication and millimeter/terahertz waves. Among such high-speed phase shifters, a phase shifter of a plasmonic optical waveguide type using an electro-optical (EO) material as a core has an operating principle that is a dielectric response by an external modulation electric field so as to cause a refractive index change, and further, is capable of serving as an ultra-small phase shifter that can be regarded as a lumped parameter element for a modulation high-frequency signal. Thus, a phase shifter of a plasmonic optical waveguide type is characteristically capable of serving as an optical modulator that can perform high-speed operations.

For example, as illustrated in FIG. 6, there is an optical modulator 300 in which cores 304a and 304b formed with an EO material are disposed between a first metal layer 302 connected to a signal line (not illustrated in the drawing) and second metal layers 303a and 303b that are connected to a ground line (not illustrated) and are disposed on both sides of the first metal layer 302 (Non Patent Literature 1 and Non Patent Literature 2). The first metal layer 302, the two second metal layers 303a and 303b, and the cores 304a and 304b that are interposed between the metal layers constitute plasmonic optical waveguides. The first metal layer 302 and the second metal layers 303a and 303b also serve as electrodes for applying voltages for driving the optical modulator 300 to the cores 304a and 304b. For example, the first metal layer 302 and the second metal layers 303a and 303b are formed on an insulating substrate 301, and a layer 305 of an EO material is formed thereon. Thus, the optical modulator 300 described above can be formed.

The voltage for driving this optical modulator is supplied as a high-frequency signal from an external modulation signal source. To obtain desired frequency characteristics of an optical transmitter including an external modulation signal source, it is important to perform high-frequency designing of each element, comprehensively taking into consideration the frequency characteristics and the output impedance of the external modulation signal source, and the input impedance and the frequency characteristics of the optical modulator including electrodes formed with the metal layers that constitute plasmonic optical waveguides.

### CITATION LIST

### Non Patent Literature

Non Patent Literature 1: W. Heni et al., “108 Gbit/s Plasmonic Mach-Zehnder Modulator with >70-GHz Electrical Bandwidth”, Journal of Lightwave Technology, vol. 34, no. 2, pp. 393-400, 2016.

Non Patent Literature 2: U. Koch et al., “A monolithic bipolar CMOS electronic-plasmonic high-speed transmitter”, Nature Electronics, vol. 3, pp. 338-345, 2020.

### SUMMARY

### Technical Problem

Meanwhile, in the above-described technology, the cores 304a and 304b formed with

an EO material exist between the first metal layer 302 and the second metal layers 303a and 303b, as illustrated in FIG. 6. Therefore, the metal layers are insulated in principle, and the input impedance of the optical modulator is infinite.

Here, in the optical transmitter of Non Patent Literature 1, a high-frequency signal from an external modulation signal source (“source”) is supplied through a line having a characteristic impedance of 50 Ω, and the optical modulator 300 is connected so as to open-terminate this line, as illustrated in an equivalent circuit in FIG. 7. For this reason, elements are not designed in accordance with the output impedance of the external modulation signal source, and the operating frequency band of the optical transmitter is not necessarily maximized. Further, reflection of a modulation high-frequency signal due to impedance mismatch between the external modulation signal source (“source”) and the optical modulator 300 is also large. Therefore, peculiar frequency dependence appearing in the frequency response characteristics of the optical transmitter is also a serious problem.

In the optical transmitter of Non Patent Literature 2, a high-frequency signal from a differentially-driven external modulation signal source is supplied to the optical modulator 300, and the optical modulator 300 is connected so as to be loaded as a concentrated capacitance in the middle of a high-frequency line between the external modulation signal source and the optical modulator 300, as illustrated in an equivalent circuit in FIG. 8. An input terminating resistor and an output terminating resistor in FIG. 8, the line shape, and each material are designed so as to exhibit desired frequency characteristics. Thus, the frequency characteristics of the optical modulator 300 can be made similar to the desired frequency characteristics.

However, the frequency characteristics of an optical modulator as described above follow the frequency characteristics of a high-frequency line. Still, there are no disclosures of a method for optimizing the frequency characteristics of an optical modulator and further maximizing the performance of the optical modulator by compensating for or improving the frequency characteristics of a high-frequency line.

Embodiments of the present invention have been made to solve the above problem and aim to optimize and maximize the high-frequency characteristics of the voltage amplitude of an optical modulator with a plasmonic optical waveguide and improve the performance of the optical modulator.

### Solution to Problem

An optical modulator according to embodiments of the present invention includes: a core that is formed with a material having an electro-optical effect and is disposed above a lower cladding layer; a first metal layer and a second metal layer that are disposed above the lower cladding layer, sandwich the core, and are in contact with the core, a high-frequency signal being applied to the first metal layer and the second metal layer; an upper cladding layer that is formed above the lower cladding layer, to cover the core, the first metal layer, and the second metal layer; a resistor that is formed on the upper cladding layer and above the core; a first penetrating wiring line that penetrates the upper cladding layer and electrically connects the resistor and the first metal layer; and a second penetrating wiring line that penetrates the upper cladding layer and electrically connects the resistor and the second metal layer. In the optical modulator, the core, the first metal layer, and the second metal layer constitute a plasmonic optical waveguide.

### Advantageous Effects of Embodiments of the Invention

As described above, according to embodiments of the present invention, a resistor is provided on an upper cladding layer above a core formed with a material having an electro-optical effect and is connected to a first metal layer and a second metal layer that sandwich the core. Thus, it is possible to optimize and maximize the high-frequency characteristics of the voltage amplitude of the optical modulator with a plasmonic optical waveguide and improve the performance of the optical modulator.

### BRIEF DESCRIPTION OF THE DRAWINGS

FIG. 1 is a cross-sectional view illustrating a configuration of an optical modulator according to a first embodiment of the present invention.

FIG. 2A is a cross-sectional view illustrating a configuration of an optical modulator

according to a second embodiment of the present invention.

FIG. 2B is a plan view illustrating a configuration of an optical modulator according to

the second embodiment of the present invention.

FIG. 3 is a circuit diagram illustrating an equivalent circuit of an optical transmitter to which an optical modulator according to the second embodiment of the present invention is applied.

FIG. 4 is a characteristics chart illustrating the frequency dependence of the high-frequency voltage to be applied between a first metal layer and a second metal layer when an optical modulator is driven with a high-frequency signal.

FIG. 5 is a circuit diagram illustrating an equivalent circuit of another optical transmitter to which an optical modulator according to the second embodiment of the present invention is applied.

FIG. 6 is a cross-sectional view illustrating a configuration of a conventional optical modulator.

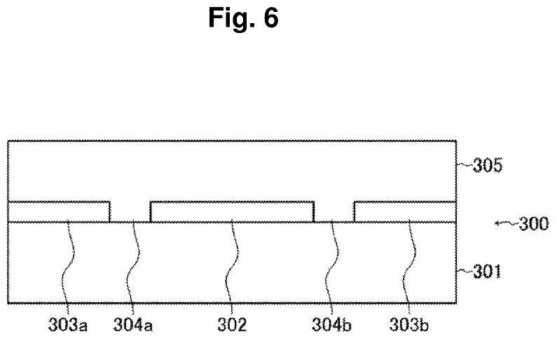

FIG. 7 is a circuit diagram illustrating an equivalent circuit of an optical transmitter of Non Patent Literature 1.

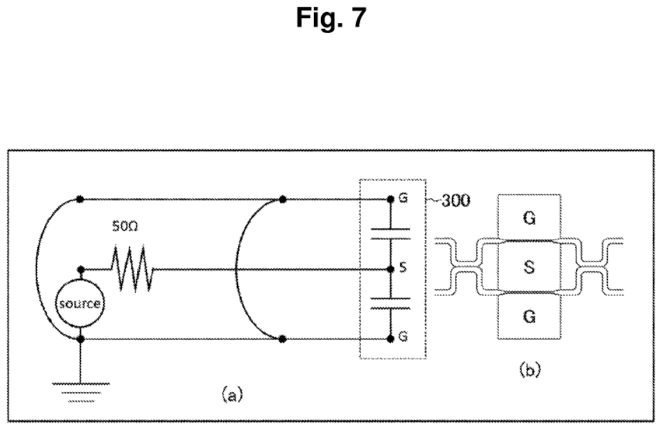

FIG. 8 is a circuit diagram illustrating an equivalent circuit of an optical transmitter of Non Patent Literature 2.

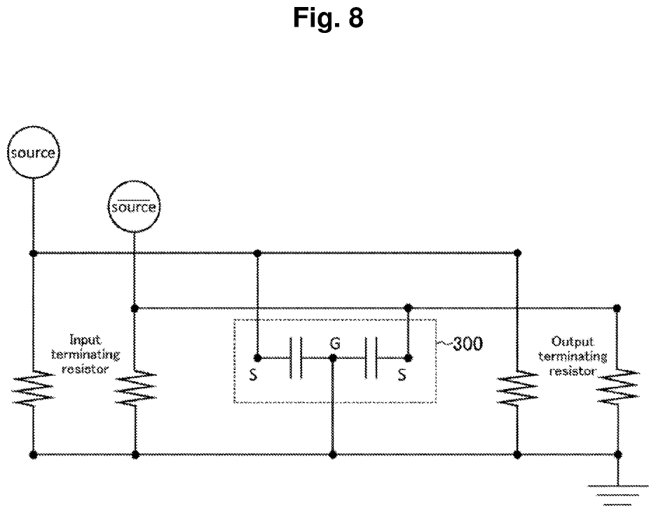

### DETAILED DESCRIPTION OF ILLUSTRATIVE EMBODIMENTS

The following is a description of optical modulators according to embodiments of the present invention.

### First Embodiment

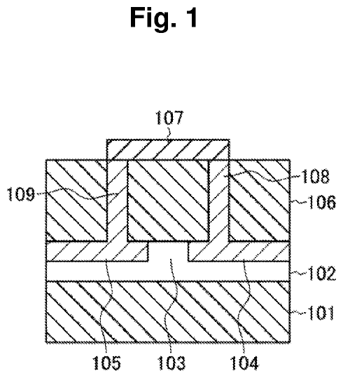

First, an optical modulator according to an embodiment of the present invention is described with reference to FIG. 1. Note that FIG. 1 illustrates a cross-section along a plane perpendicular to the waveguide direction. This optical modulator includes a core 103 formed above a lower cladding layer 101, and a first metal layer 104 and a second metal layer 105 disposed above the lower cladding layer 101, with the core 103 being interposed in between.

The core 103 is formed with a material that has an electro-optical effect. The first metal layer 104 and the second metal layer 105 are formed in contact with both side surfaces of the core 103, and the core 103, the first metal layer 104, and the second metal layer 105 constitute a plasmonic optical waveguide. Further, a high-frequency signal is applied to the first metal layer 104 and the second metal layer 105.

In this example, a slab layer 102 formed with a material that has an electro-optical effect is provided on the lower cladding layer 101, and the core 103 is formed on and in contact with the slab layer 102. For example, the slab layer 102 and the core 103 are integrally formed. The core 103 and the slab layer 102 constitute a well-known rib-type optical waveguide.

The above-mentioned material having an electro-optical effect may be lithium niobate (LiNbO₃), for example. Also, the above-mentioned material may be a ferroelectric perovskite crystalline oxide such as BaTiO₃, LiNbO₃, LiTaO₃, or KTN, or a cubic perovskite crystalline oxide such as KTN, BaTiO₃, SrTiO₃, or Pb₃MgNb₂O₉, for example. Further, the above-mentioned material may be a KDP crystal, a zinc blende oxide crystal, or the like.

The first metal layer 104 and the second metal layer 105 can be formed with Au, for example. The first metal layer 104 and the second metal layer 105 may be metals capable of exciting surface plasmon polariton (SPP) at the interface with the core 103 for light having a wavelength to be guided in the plasmonic optical waveguide, and are not limited to Au, but may be Ag, Al, Cu, Ti, Pt, or the like, for example.

This optical modulator also includes an upper cladding layer 106 formed above the lower cladding layer 101, and covering the core 103, the first metal layer 104, and the second metal layer 105. The lower cladding layer 101 and the upper cladding layer 106 can be formed with an oxide such as silicon oxide, for example.

In addition to the above, this optical modulator includes a resistor 107 formed on the upper cladding layer 106 and above the core 103. The resistor 107 is electrically connected to the first metal layer 104 by a first penetrating wiring line 108 penetrating the upper cladding layer 106. The resistor 107 is also electrically connected to the second metal layer 105 by a second penetrating wiring line 109 penetrating the upper cladding layer 106. The resistor 107 may be formed with a resistive material such as titanium nitride or tungsten nitride. Also, the resistor 107 may be formed with a semiconductor such as Si into which an impurity exhibiting a predetermined conductivity type has been introduced.

In the optical modulator according to the first embodiment, the first metal layer 104, the second metal layer 105, and the core 103 constitute a phase shifter, a high-frequency signal is supplied from an external modulation signal source (not illustrated in the drawing) to the first metal layer 104 and the second metal layer 105, and an electric field generated by the supplied high-frequency signal is applied to the core 103. Thus, the phase of the light being guided in the plasmonic optical waveguide is modulated. Also, in this optical modulator, the resistor 107 is connected to the first metal layer 104 and the second metal layer 105 in parallel with the core 103, and thus, parasitic components can be reduced.

With this optical modulator, the resistor 107 makes it possible to form a high-frequency design that takes into consideration the frequency characteristics and the output impedance of the external modulation signal source and the input impedance and the frequency characteristics of the optical modulator including the first metal layer 104 and the second metal layer 105 constituting the plasmonic optical waveguide. As a result, the high-frequency characteristics of the voltage amplitude of the optical modulator with the plasmonic optical waveguide can be optimized and maximized, and the performance of the optical modulator can be improved.

### Second Embodiment

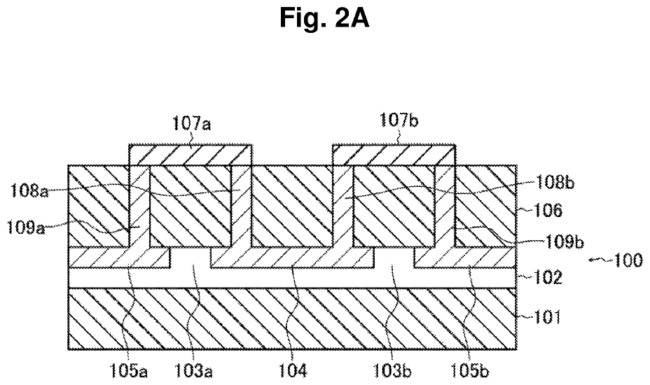

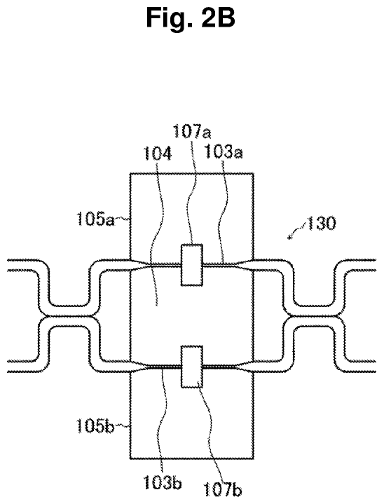

Next, a second embodiment of the present invention is described with reference to FIGS. 2A and 2B. Note that FIG. 2A illustrates a cross-section along a plane perpendicular to the waveguide direction. An optical modulator 100 according to the second embodiment includes two cores 103a and 103b that are formed above a lower cladding layer 101. The two cores 103a and 103b extend in parallel with each other. The core 103a and the core 103b are formed with a material that has an electro-optical effect.

In this example, a slab layer 102 formed with a material that has an electro-optical effect is provided on the lower cladding layer 101, and the cores 103a and 103b are formed on and in contact with the slab layer 102. For example, the slab layer 102 and the cores 103a and 103b are integrally formed. The core 103a and the slab layer 102 constitute a well-known rib-type optical waveguide. Likewise, the core 103b and the slab layer 102 constitute a rib-type optical waveguide. The above-mentioned material having an electro-optical effect may be lithium niobate (LiNbO₃), for example. Also, the width of the cores 103a and 103b may be 40 nm, and the core height may be 100 nm. Further, the thickness of the slab layer 102 is 100 nm, and the waveguide length is 10 μm.

A first metal layer 104, and two second metal layers 105a and 105b that are arranged so as to sandwich the cores 103a and 103b are also provided above the lower cladding layer 101. The two second metal layers 105a and 105b corresponding to the two cores 103a and 103b are provided. The first metal layer 104 is disposed to be interposed between the two cores 103a and 103b. Also, the second metal layer 105a and the first metal layer 104 are disposed with the core 103a being interposed in between. Further, the second metal layer 105b and the first metal layer 104 are disposed with the core 103b being interposed in between. The respective cores and the respective metal layers are formed in contact with the respective side surfaces in the planar direction of the lower cladding layer 101.

The optical modulator 100 also includes an upper cladding layer 106 formed above the lower cladding layer 101, covering the two cores 103a and 103b, the first metal layer 104, and the two second metal layers 105a and 105b. The upper cladding layer 106 may be 3 μm in thickness, for example.

With the above-described configuration, the core 103a, the first metal layer 104, and the second metal layer 105a constitute a plasmonic optical waveguide and also constitute a phase shifter. Likewise, the core 103b, the first metal layer 104, and the second metal layer 105b constitute a plasmonic optical waveguide and also constitute a phase shifter.

Further, the two cores 103a and 103b are disposed in the two respective arms of a Mach-Zehnder interferometer 130 that is normally used in existing optical modulators. The plasmonic optical waveguide by the core 103a forms one arm of the Mach-Zehnder interferometer 130, and the plasmonic optical waveguide by the core 103b forms the other arm of the Mach-Zehnder interferometer 130. Note that each arm of the Mach-Zehnder interferometer 130 is connected to a LN-on-insulator (LNoI) dielectric optical waveguide via a mode converter. This dielectric optical waveguide is a rib-type optical waveguide and has a core width of 1 μm, a core height of 100 nm, and a slab thickness of 100 nm, for example. The plasmonic optical waveguides and the dielectric optical waveguide are formed above the lower cladding layer 101. Further, the upper cladding layer 106 is formed for both the plasmonic optical waveguides and the dielectric optical waveguide.

Also, a signal line is connected to the first metal layer 104, a ground line is connected to the two second metal layers 105a and 105b, and a high-frequency signal is applied to the cores 103a and 103b through these coplanar lines.

The optical modulator 100 according to the second embodiment also includes two resistors 107a and 107b corresponding to the two cores 103a and 103b. The two resistors 107a and 107b are formed on the upper cladding layer 106. The resistor 107a is formed on the upper cladding layer 106 and above the core 103a. The resistor 107b is formed on the upper cladding layer 106 and above the core 103b.

Two first penetrating wiring lines 108a and 108b corresponding to the first metal layer 104 and the two resistors 107a and 107b are also provided. Note that the resistor 107a is electrically connected to the second metal layer 105a by a second penetrating wiring line 109a. Also, the resistor 107b is electrically connected to the second metal layer 105b by a second penetrating wiring line 109b. Each penetrating wiring line is formed to penetrate the upper cladding layer 106.

As the resistors 107a and 107b are provided, parasitic components can be reduced as in the first embodiment described above. Further, the resistors 107a and 107b are connected so as to straddle over the cores 103a and 103b of the plasmonic optical waveguides having stronger optical confinement, instead of over the dielectric optical waveguide. Thus, influence on propagating light can be reduced.

A signal line is connected to the first metal layer 104, part of which serves as an

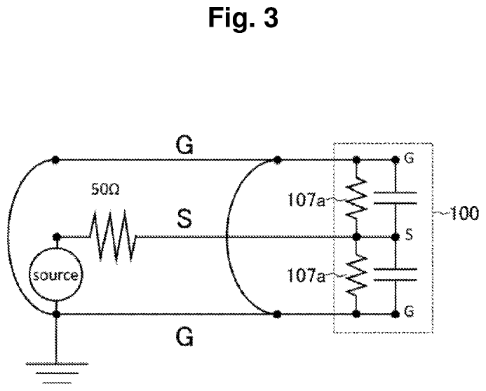

electrode pad. Also, a ground line is connected to each of the two second metal layers 105a and 105b, each of which partially serves as an electrode pad. For example, as illustrated in an equivalent circuit in FIG. 3, a high-frequency signal from an external modulation signal source (“source”) is supplied through a signal line having a characteristic impedance of 50 Ω and a high-frequency line (a coplanar line) formed with a ground line. The optical modulator 100 is also connected to this high-frequency line.

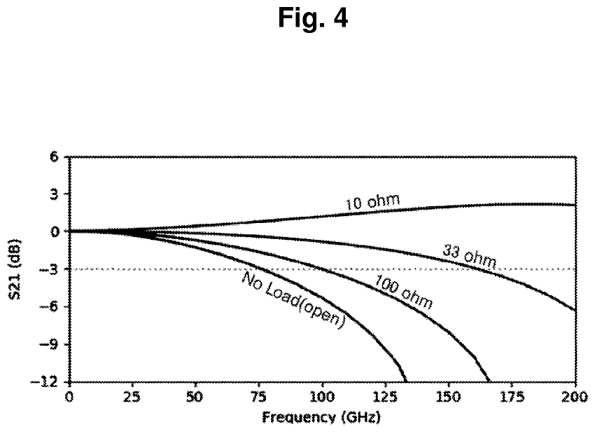

In the description below, the frequency dependence of the high-frequency voltage to be applied between the first metal layer 104 and the second metal layer 105a (the second metal layer 105b) when the optical modulator 100 is driven with a modulation signal supplied through the above-described high-frequency line is explained. FIG. 4 illustrates the frequency dependence of the high-frequency voltage. In the graph in FIG. 4, the ordinate axis indicates a logarithmic representation of the high-frequency voltage amplitude to be applied between the first metal layer 104 and the second metal layer 105a (the second metal layer 105b), the high-frequency voltage amplitude being normalized by the high-frequency voltage amplitude to be applied between the signal line of the high-frequency line and the ground line. FIG. 4 also illustrates the frequency responses to the respective resistance values in a case where the resistance values of the respective resistors 107a and 107b of the phase shifter by the core 103a and the phase shifter by the core 103b are changed.

In a case where no resistors are provided [No Load (Open)], the −3 dB band is about 75 GHz. On the other hand, it can be seen that, in a case where resistors 107a and 107b of 100 ohm are provided so as to easily match with the impedance of the input line, the −3 dB band is broadened to about 100 GHz. This can be substantially regarded as a 50-ohm terminated state.

Further, where resistors 107a and 107b of 33 ohm are provided, the −3 dB band is broadened to about 160 GHz. Where resistors 107a and 107b of 10 ohm are provided, the −3 dB band is broadened to 200 GHz or higher. Note that the absolute value of the voltage amplitude also changes with each of the resistance values of the resistors 107a and 107b, particularly since the voltage amplitude becomes smaller as the resistance becomes lower. Therefore, it is preferable to appropriately set the resistance values with the frequency band and the voltage amplitude being taken into consideration.

Note that, as for the results described above, if each dimension of the core 103a (the core 103b) and the waveguide length of the plasmonic optical waveguides change, the optimum resistance values of the resistors 107a and 107b also change. Further, the parasitic capacitance of the optical modulator also changes with a change in the electrode pad structure that is provided in each metal layer to apply a high-frequency modulation signal. Therefore, the optimum resistance values of the resistors 107a and 107b for obtaining desired frequency characteristics also change accordingly.

As described above, the optical modulator 100 using phase shifters formed with plasmonic optical waveguides is connected as a terminating element of a high-frequency line, and the resistors 107a and 107b having appropriate resistance values depending on the structure of the phase shifters are provided. Thus, it is possible to obtain desired frequency characteristics by changing the frequency characteristics of the voltage to be applied to the respective metal layers sandwiching the cores 103a and 103b that determine the frequency characteristics of the optical modulator.

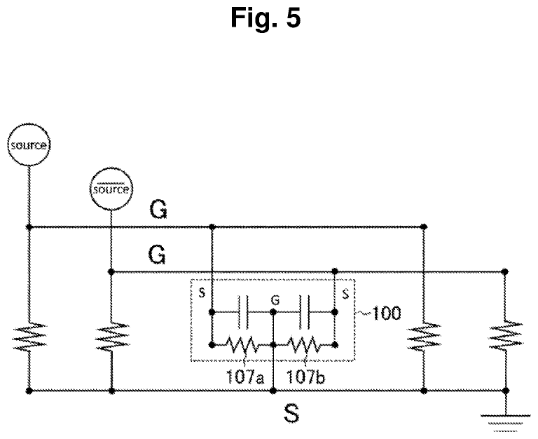

Meanwhile, as illustrated in an equivalent circuit in FIG. 5, it is also possible to supply a high-frequency signal from a differentially-driven external modulation signal source to the optical modulator 100 and connect the optical modulator 100 so as to be loaded as a concentrated capacitance in the middle of a high-frequency line between the external modulation signal source and the optical modulator 100. An input terminating resistor and an output terminating resistor in FIG. 5, the line shape, and each material are designed so as to exhibit desired frequency characteristics. Thus, the frequency characteristics of the optical modulator 100 can be made similar to the desired frequency characteristics.

In a case where a differential signal is output from a high-speed external modulation signal source, the resistors 107a and 107b are used even for a coplanar line in which signal lines S and ground lines G are designed as G-S-G-S-G. Thus, it is possible to obtain desired frequency characteristics by changing the frequency characteristics of the voltage to be applied between the respective metal layers that sandwich the cores 103a and 103b constituting the optical modulator 100. This can provide the optical modulator 100 with flat frequency characteristics that follow the frequency characteristics of the coplanar line or can provide the optical modulator 100 with different frequency characteristics that compensate for the band of the frequency characteristics of the coplanar line or further increase the voltage amplitude to be applied to the optical modulator 100 to a larger amplitude than the amplitude propagating in the coplanar line. With the above arrangement, such excellent effects can be achieved.

As described so far, according to embodiments of the present invention, a resistor is provided on an upper cladding layer above a core formed with a material having an electro-optical effect and is connected to a first metal layer and a second metal layer that sandwich the core. Thus, it is possible to optimize and maximize the high-frequency characteristics of the voltage amplitude of the optical modulator with a plasmonic optical waveguide and improve the performance of the optical modulator.

Note that it is obvious that the present invention is not limited to the embodiments described above, but can be modified and combined in many ways by a person with ordinary knowledge in the art within the technical idea of the present invention.

### REFERENCE SIGNS LIST

101 lower cladding layer
102 slab layer
103 core
104 first metal layer
105 second metal layer
106 upper cladding layer
107 resistor
108 first penetrating wiring line
109 second penetrating wiring line

1.-4. (canceled)

5. An optical modulator comprising:
a core above a lower cladding layer, the core comprising a material having an electro-optical effect;
a first metal layer and a second metal layer on each side of the core in a cross-sectional view, wherein the first metal layer and the second metal layer are in physical contact with the core to constitute a plasmonic optical waveguide, and wherein a high-frequency signal is to be applied to the first metal layer and the second metal layer;
an upper cladding layer above the lower cladding layer and covering the core, the first metal layer, and the second metal layer;
a resistor on the upper cladding layer and above the core;
a first penetrating wiring line penetrating the upper cladding layer and electrically connecting the resistor and the first metal layer; and
a second penetrating wiring line penetrating the upper cladding layer and electrically connecting the resistor and the second metal layer.

6. The optical modulator according to claim 5, further comprising a slab layer on the lower cladding layer, the slab layer comprising a second material having the electro-optical effect, wherein the core is on the slab layer.

7. The optical modulator according to claim 6, wherein the core physically contacts the slab layer.

8. The optical modulator according to claim 5, further comprising a slab layer on the lower cladding layer, the slab layer comprising the material having the electro-optical effect, wherein the slab layer and the core are a single structure with the core on the slab layer.

9. An optical modulator comprising:
two cores extending in parallel with each other above a lower cladding layer, each of the cores comprising a material having an electro-optical effect, wherein each of the two cores is disposed in each of two arms of a Mach-Zehnder interferometer, respectively;
a first metal layer interposed between the two cores and two second metal layers disposed on outermost sides of the core in a cross-sectional view, wherein the first metal layer and the second metal layers are in physical contact with the two cores to constitute plasmonic optical waveguides, and wherein a high-frequency signal is to be applied to the first metal layer and the second metal layers;
an upper cladding layer above the lower cladding layer and covering the core, the first metal layer, and the second metal layers;
two resistors on the upper cladding layer and above each of the two cores, respectively;
two first penetrating wiring lines penetrating the upper cladding layer and electrically connecting the two resistors and the first metal layer, respectively;
two second penetrating wiring lines each penetrating the upper cladding layer and electrically connecting the two resistors and the two second metal layers, respectively;
a signal line connected to the first metal layer; and
a ground line connected to each of the two second metal layers.

10. The optical modulator according to claim 9, further comprising a slab layer on the lower cladding layer, the slab layer comprising a second material having the electro-optical effect, wherein the two cores are on the slab layer.

11. The optical modulator according to claim 10, wherein the two cores physically contact the slab layer.

12. The optical modulator according to claim 9, further comprising a slab layer on the lower cladding layer, the slab layer comprising the material having the electro-optical effect, wherein the slab layer and the two cores are a single structure with the two cores on the slab layer.
